(19) United States
(12) Patent Application Publication
(10) Pub. No.: US 2010/0295417 A1
(43) Pub. Date: Nov. 25, 2010

(54) Multi-Segmented Spine with Integrated Actuation

(75) Inventors: Robert J. Wood, Cambridge, MA (US); Kyujin Cho, Yong-In (KR); Elliot W. Hawkes, Tallahassee, FL (US)

Correspondence Address: MODERN TIMES LEGAL, ONE BROADWAY , 14TH FLOOR, CAMBRIDGE, MA, 02142, US

(73) Assignee: PRESIDENT AND FELLOWS OF HARVARD COLLEGE, Cambridge, MA (US)

(21) Appl. No.: 12/784,899

(22) Filed: May 21, 2010

Related U.S. Application Data
(60) Provisional application No. 61/180,423, filed on May 21, 2009.

(51) Int. Cl. H02N 10/00; B25J 11/00

(52) U.S. Cl. 310/306; 74/490.09

(57) ABSTRACT

A multi-segmented spine includes a plurality of rigid segments joined with a flexible coupling and governed by a plurality of integrated actuators. Motion is generated in the multi-segmented spine via an intelligent activation sequence for the actuators, which can be in the form of shape memory alloys activated via resistance heating from electric current.

### RELATED APPLICATION

This application claims the benefit of U.S. Provisional Application No. 61/180,423, filed May 21, 2010, the entire content of which is incorporated herein by reference.

### BACKGROUND

Studies have identified several types of locomotion that fish use to generate thrust. Most fish generate thrust by bending their bodies into a backward-moving propulsive wave that extends to the caudal fin, a type of swimming classified under body and/or caudal fin (BCF) locomotion. The propulsive wave traverses the fish body in a direction opposite to the overall movement and at a speed greater than the overall swimming speed. There are four undulatory BCF locomotion modes identified by their amplitude envelope of the propulsive wave: anguilliform, subcarangiform, carangiform and thunniform. Despite these labels placed by biologists, two-dimensional analyses of fish locomotion have shown that even fish of very different body types show extremely similar patterns of body movement when viewed in a horizontal section during steady undulatory locomotion.

Large scale robotic fish have been built by several researchers. One study describes a robotic fin to emulate the anguilliform mode [A. Willy, et al., “Development and initial experiment of modular undulating fin for untethered biorobotic AUVs,” 2005 Proc. IEEE Int. Conf. Robotics and Biomimetics (ROBIO), pp. 45-50]. Other studies describe a robotic testbed for the study of carangiform swimming [K. Morgansen, et al., “Nonlinear control methods for planar carangiform robot fish locomotion,” 2001 Proc. IEEE Int. Conf. Robotics and Automation, pp. 427-343; and K. Morgansen, et al., “Trajectory stabilization for a planar carangiform robot fish,” in 2002 Proc. IEEE Int. Conf. Robotics and Automation, pp. 756-762]. Additionally, the MIT RoboTuna is an example of a robotic thunniform swimmer [G. S. Triantafyllou, et al., “An efficient swimming machine,” Sci. Amer., pp. 64-70, 1995].

An actuator for a minnow-size robotic fish preferably is compact and lightweight while providing sufficient displacement and force to deflect fin sections to a desired angle at an operational speed of 2-4 Hz. The actuator preferably also is durable enough to operate thousands of cycles and is low cost and easy to assemble. Some of the actuators that were considered for this role include ionic polymer metal composites (IPMCs), dielectric elastomers, piezoelectrics, and shape memory alloys. IPMCs have been used extensively for water-based robotics [R. Kornbluh, et al., “Electrostrictive polymer artificial muscle actuators,” 1998 Proc. IEEE Int. Conf. Robotics and Automation, vol. 3, pp. 2147-2154; and Y. Fu, et al., “Design, fabrication and testing of piezoelectric polymer PVDF microactuators,” Smart Materials & Structures, vol. 15, no. 1, pp. 141-146, 2006], as their need to be immersed in an ion-rich fluid makes them a natural choice. Dielectric elastomers are notable for being employed in a large number of geometries and for having very large deformations. Both piezoelectric ceramics and polymers are well known for being capable of operating above 1 kHz at moderate voltages, and the ceramics can also generate large stresses. Fukuda et al. have used a pair of PZT actuators along with an amplification mechanism for a swimming microrobot [T. Fukuda, et al., “Mechanism and swimming experiment of micro mobile robot in water,” 1994 Proc. IEEE Int. Conf. Robotics and Automation, A. Kawamoto, Ed., vol. 1, pp. 814-819]. Shape memory alloy (SMA) actuators have large energy density and a unique two-phase (martensite/austenite) property. SMA actuators have been described for us in actuated robotic hands [K.-J. Cho, et al., “Multi-axis SMA actuator array for driving anthropomorphic robot hand,” 2005 Proc. IEEE Int. Conf. Robotics and Automation, pp. 1356-1361], in crawling microrobots [B. Trimmer, et al., “Caterpillar locomotion: A new model for soft-bodied climbing and burrowing robots,” 7th Int. Symp. Technology and the Mine Problem, 2006], and in several robotic fish fins [N. Ono, et al., “Design of fish fin actuators using shape memory alloy composites,” 2004 Proc. SPIE, vol. 5388, pp. 305-312; O. K. Rediniotis, et al., “Development of a shape-memory-alloy actuated biomimetic hydrofoil,” J. of Intelligent Material Systems and Structures, vol. 13, no. 1, pp. 35-49, 2002; N. Shinjo, et al., “Use of a shape memory alloy for the design of an oscillatory propulsion system,” IEEE Journal of Oceanic Engineering, vol. 29, no. 3, pp. 750-755, 2004; and Z. Yonghua, et al., “Development of an underwater oscillatory propulsion system using shape memory alloy,” 2005 IEEE Int. Conf. Mechatronics and Automation, vol. 4, pp. 1878-1883].

### SUMMARY

The design and fabrication of millimeter- or centimeter-scale multi-segmented spines that include an articulated network with an integrated actuation system are described herein. Both the articulated network and the actuation system are simple and compact. A plurality of rigid segments are joined via a flexible coupling with an integrated actuator to pivot the rigid segments relative to one another. This discussion focuses primarily upon the use of electrically actuated shape memory alloys to generate motion, though other actuator systems and other means of activation can be employed. Additionally, the small-scale spines described herein can readily be scaled up in terms of size and number of segments.

In one embodiment, the actuators are shape memory alloy (SMA) springs that are customized to provide the necessary work output for a microrobotic fish to move the fish in an aquatic environment. Alternative modes of movement can be modeled by changing, e.g., the size, shape, number and/or configuration of rigid segments as well as the diameter of the springs and/or by changing the timing and sequence with which the springs are actuated. The choice of SMA spring actuation is based on the large space of force and displacement this morphology will allow. Furthermore, shape memory alloys are resilient and easy to handle and fabricate. In other embodiments, the movements of other biological organisms are simulated and types of actuators other than SMAs are employed (e.g., any structural element that changes shape and produces linear or rotational displacement due to an external stimulus, such as electricity, temperature change, light, change in pH, or chemical reaction).

With a novel SMA spring design and a flexure-based skeleton, the smallest multi-segmented robotic fish fin using SMA actuators to date can be built. An embodiment of this device has five 6 mm square segments that are 250 μm thick and four SMA spring actuators that are 200 μm in diameter. The total length of the device is about 40 mm, with the 0.25 mm maximum thickness and 6 mm width. At this scale, joints are made using flexures. Electrical wiring, as well as the attachment of SMA springs, is simplified by a patterned copper-laminated polymer film that is used for the flexure material. While this design is for a small degree-of freedom (DOF) fin, it is easily iterated for large DOF swimming fish, as actual fish locomotion is quite complex.

The flexure joints, electrical wiring and attachment pads for SMA actuators are all embedded in a single layer of copper-laminated polymer film, sandwiched between two layers of rigid glass fiber with kapton flexures. Instead of using individual actuators to rotate each joint, each actuator rotates all the joints to a certain mode shape; and undulatory motion is created by a timed sequence of these mode shapes. The subcarangiform swimming mode of minnows (where waves are propagated posteriorly along the fish length, propelling it forward) has been emulated using five links and four actuators.

Though the description herein is particularly focused on the subcarangiform swimming mode as the basis of the undulatory motion created by a robotic fish, these principles can readily be employed for other modes of locomotion (e.g., by changing the size and shapes of linkages or by changing the timing and sequence by which the actuators are activated) and to replicate the motions of other organisms (e.g., where joints and the pivoting of linked segments create motion). Other organisms whose movements can be replicated include elephants (e.g., the movement of their trunks), octopi (e.g., the movement of their arms), and snakes.

Additionally, by employing a procedure for annealing a shape memory alloy at various temperatures, a spring with discrete contraction lengths can be created—as opposed to the on/off contraction behavior of current shape-memory-alloy springs. For SMA spring annealing, a nickel titanium wire is annealed into a coiled spring, as is regularly done, but each section is annealed at a slightly different temperature. These differences in annealing temperatures are achieved by coiling each section of the spring around a separate metal rod, through which electricity is passed until the desired temperature is reached in each. It is well known that the transition temperature of an SMA varies with the temperature at which it is annealed (e.g., with higher transition temperatures resulting from higher annealing temperatures); and the annealing is performed at a series of temperatures so that the transition temperatures fall in a range that varies nearly linearly with annealing temperature. Consequently, as the annealed spring is held at a relatively low temperature (e.g., slightly above the transition temperature of the first spring), only the first section of the spring contracts. When the spring temperature is increased to above the transition temperature of the second section of the spring, the second section contracts. Similarly, the third and remaining sections contract at sequentially increasing temperatures. The transition temperatures of the springs can span a range, e.g., of at least 4° C. Thus, a spring is created that can have several discrete contraction lengths as a function of temperature.

Applications for such devices include environmental monitoring, surveillance, search and rescue, and in vivo diagnosis.

### BRIEF DESCRIPTION OF THE DRAWINGS

FIG. 1 illustrates a body and/or caudal fin (BCF) propulsion mechanism based upon a novel ‘meso’-scale manufacturing paradigm referred to as smart composite microstructures, wherein the spine is created with a sequence of rigid links separated by flexure joints, wherein a magnified view of a section of the spine is shown as FIG. 1a.

FIG. 2 illustrates BCF propulsion using antagonistic actuation at each joint.

FIG. 3 is a plot showing that the shear modulus of the shape memory alloy (SMA) can be adjusted by the choice of annealing temperature.

FIG. 4 illustrates basic C-type building blocks for creating motion.

FIG. 5 illustrates basic S-type building blocks for creating motion.

FIGS. 6-9 illustrates the creation of subcarangiform BCF motion with four modes, wherein the contracted springs are illustrated in each mode; a traveling wave is created as each mode is sequentially activated in this segment from FIG. 6 to FIG. 9.

FIG. 10 illustrates the annealing of an SMA spring actuator, wherein SMA wire is wound around a conducting “mold” wire that heats the SMA wire during annealing.

FIG. 11 shows annealed SMA springs, unstretched and stretched; the penny at lower right provides size comparison.

FIGS. 12-16 provide an overview of the laser micromachining step of the smart composite microstructure (SCM) fabrication process. FIG. 12 shows laser cutting of a composite prepreg and thin-film polymer laminae to desired planform geometries. A magnified view of the laser-cut prepreg surface is shown in FIG. 12a

FIG. 13 shows the prepreg segments produced by the laser-cutting step of FIG. 12 laid out on a substrate.

FIG. 14 shows the laid-out prepreg segments of FIG. 13 with a copper-laminated polyimide foil laid across the top of the segments.

FIG. 15 shows the structure of FIG. 14 with additional laser-cut prepreg segments positioned on top of the copper-laminated polyimide foil.

FIG. 16 shows the structure of FIG. 16 after curing, when the layers are bonded and removed from the underlying substrate, thereby forming the multi-segmented spine.

FIG. 17 illustrates a copper-laminated polyimide layer patterned and etched to accommodate electrical wiring and attachment points for the SMA actuators.

FIG. 18 illustrates a five-segment spine with electrical wiring, actuator attachment pads, stopper positioning holes, and flexures.

FIG. 19 illustrates a completed robotic fish fin with four joints.

FIG. 20 is a chart demonstrating the antagonistic activation characteristics for a single joint.

FIG. 21 is a chart showing the maximum bending angle for various activation times.

FIG. 22 is a chart showing that activation time decreases exponentially with the magnitude of current applied to the actuator.

FIGS. 23-26 show the sequential activation of the four modes of the BCF propulsion mechanism.

### DETAILED DESCRIPTION

The foregoing and other features and advantages of various aspects of the invention(s) will be apparent from the following, more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise defined, terms (including technical and scientific terms) used herein have the same meaning as commonly understood by one of ordinary skill in the art to which the invention belongs. It will be further understood that terms, such as those defined in commonly used dictionaries, are to be interpreted as having a meaning that is consistent with their meaning in the context of the relevant art and are not to be interpreted in an idealized or overly formal sense unless expressly so defined herein. For example, if a particular composition is referenced, practical and imperfect realities may apply; e.g., the potential presence of at least trace impurities (e.g., at less than 0.1% by weight or volume) can be understood as being within the scope of the description; likewise, if a particular shape is referenced, the shape is intended to include imperfect variations from ideal shapes, e.g., due to machining tolerances.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Spatially relative terms, such as “above,” “upper,” “beneath,” “below,” “lower,” and the like, may be used herein for ease of description to describe the relationship of one element to another element, as illustrated in the figures. It will be understood that the spatially relative terms are intended to encompass different orientations of the apparatus in use or operation in addition to the orientation depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly.

Further still, in this disclosure, when an element is referred to as being “on,” “connected to” or “coupled to” another element, it may be directly on, connected or coupled to the other element or intervening elements may be present unless otherwise specified.

The terminology used herein is for the purpose of describing particular embodiments and is not intended to be limiting of exemplary embodiments. As used herein, the singular forms, “a,” “an” and “the,” are intended to include the plural forms as well, unless the context clearly indicates otherwise. Additionally, the terms, “includes,” “including,” “comprises” and “comprising,” specify the presence of the stated elements or steps but do not preclude the presence or addition of one or more other elements or steps.

### I. Apparatus Design

A. Basic Concept

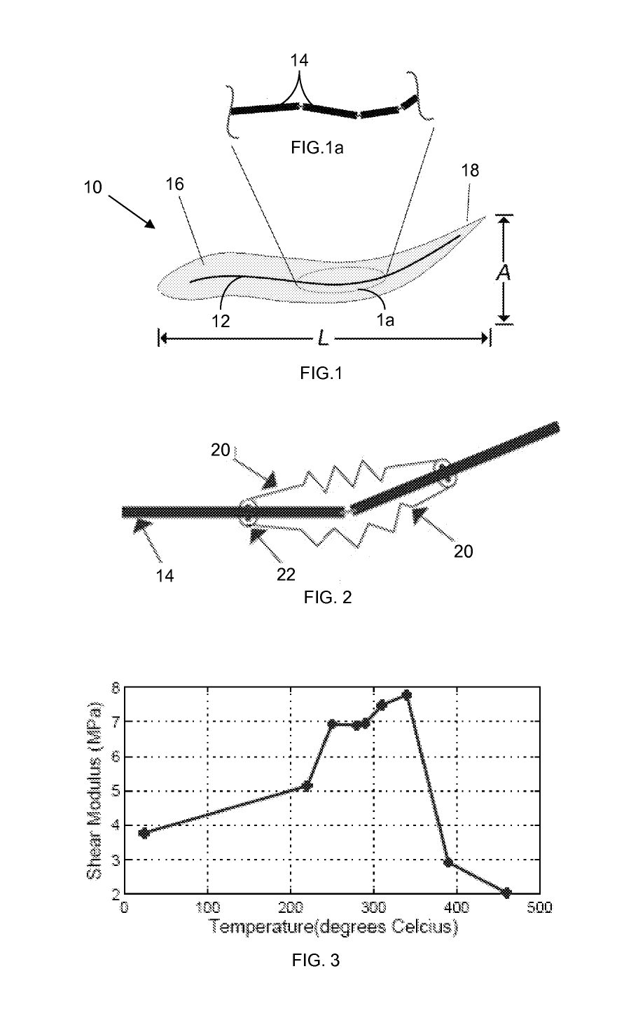

A basic concept of a microrobotic fish 10 is displayed in FIG. 1 and is composed of a flexure-jointed composite fiber spine 12 formed of a plurality of segments 14 covered with a skin 16 formed, for example, of polydimethylsiloxane (PDMS). The motion of the caudal fin 18 is driven by springs comprising a shape memory alloy (SMA), such as a copper-zinc-aluminum-nickel alloy, a copper-aluminum-nickel alloy, or a nickel-titanium (NiTi) alloy. The springs 20 are attached via solder 22 on either side of each flexure segment 14 (see FIG. 2) and are actuated in succession to create a traveling waveform; in FIG. 2, the top spring 20 is actuated.

B. Actuator Selection

In past iterations of the BCF propulsion mechanism, straight wires formed of a shape memory alloy were used with little success because the force generated by the wire was too large to allow for a robust attachment. A spring configuration is adopted here that not only decreases the surplus of force but also increases deflection, allowing for well over 100% strain. This excess strain creates more motion in the tail and allows for ease in mounting, as the spring can be stretched, attached, then actuated to return to working length. The design of the spring has multiple parameters that must be considered based on the deflection of the spring, δ, and the spring constant, k, which are given as follows:

$$\begin{matrix}δ = \frac{8 {PD}^{3} n}{{Gd}^{4}} , and & ( 1 ) \\ k = \frac{{Gd}^{4}}{8 {D}^{3} n} & ( 2 )\end{matrix}$$

[see K. Otsuka et al., Shape Memory Materials. Cambridge, UK: Cambridge University Press, 1998]. In the above equations, D is the spring diameter measured from the center of wire on either side; d is the wire diameter; n is the number of active coils in the spring; P is the load; and G is the shear modulus of the SMA wire after annealing.

Thus, to adjust the spring constant, k, one can choose from among the following three parameters: wire diameter, d; spring diameter, D; and the number of active coils, n. Reducing the wire diameter, d, is advantageous, as this reduction decreases cooling time. The number of active coils, n, is limited by the length of spring needed. Consequently, one is left with spring diameter, D, to minimize as much as possible without decreasing the deflection outside of a useful range. Accordingly, a spring index, D/d, is chosen between 2.5 and 3.

However, one more parameter can be altered—namely, G, the shear modulus. The value of G for the austenite phase of a spring is around 3.77 MPa when the wire is plastically deformed into a coil and not annealed. This value can be increased to almost 7.8 MPa when the wire is annealed (see FIG. 3). By annealing slightly above 300 degrees (measured externally with a thermocouple; the actual internal temperature is higher) the shear modulus is increased. By understanding the annealing process and the model in Eq. 1 and Eq. 2, above, a geometry can be chosen that provides the desired stress and strain to achieve the individual flexure motion.

C. Flexure Design

The flexure segments 14 are designed to avoid buckling under normal operation while remaining sufficiently compliant (compared with the actuator stiffness). Flexure segments 14 are made with a custom process using thin-film polymers sandwiched between rigid composite plates [see R. Wood, et al., “Microrobot design using fiber reinforced composites,” J. of Mechanical Design, May 2008]. Polymers are chosen for resilience and high elastic strain limit (allowing large motions with compact geometries) [see S. Avadhanula, et al., “Flexure design rules for carbon fiber microrobotic mechanisms,” 2005 Proc. IEEE Int. Conf. Robotics and Automation, pp. 1579-1584]. However, in this case, current is passed through each flexure segment 14 to power more-distal actuators on adjacent segments 14. To accomplish this result, patterned copper laminated on a thin-film polymer 24 is used (see FIG. 8). Special care is therefore taken in designing the flexure geometry to avoid plastic deformations while keeping the stiffness low. Initially, the pseudo-rigid-body model of a compliant mechanism assumes that the flexure can be conceptually replaced by a perfect pin joint in parallel with a rotational flexure. The spring constant, k_{θ}, of this flexure can be expressed as follows:

$${k}_{θ} = \frac{EI}{L} . \qquad ( 3 )$$

Since the beam is a composite, the effective modulus and the second moment of area of the flexure are determined for use in Eq. 3. This determination is made using a standard transformation for a composite beam. First, the width of the polymer section, wₚ, is multiplied by a factor, n, which is the ratio of the modulus of the polymer to the modulus of the conductor (n=Eₚ/E_{c}). This calculation results in a transformed homogeneous beam with modulus, E_{c}. Determining the second moment of area of this beam involves the following two steps: (1) determining the location of the neutral axis, and (2) using this neutral axis and the parallel axis theorem to calculate the second moment of area. Since the transformed area can be broken down into two rectangular areas, the location of the neutral axis, Y̅, is defined as follows:

$$\overline{Y} = \frac{\sum {\overline{y}}_{i} {A}_{i}}{\sum {A}_{i}} = \frac{( {h}_{p} + {h}_{c} / 2 ) {w}_{c} {h}_{c} + ( {h}_{p} / 2 ) {nw}_{p} {h}_{p}}{{w}_{c} {h}_{c} + {nw}_{p} {h}_{p}} . \qquad ( 4 )$$

In the above equation, y̅ᵢ is the distance from the bottom edge of the beam to the centroid of each area; and Aᵢ is the area of each section. The second moment of area, I′, is now found via the following equation:

$$\begin{matrix}{I}^{′} = \sum \frac{{w}_{i} {h}_{i}^{3}}{12} + {A}_{i} {d}_{i}^{2} \\ = \frac{{w}_{c} {h}_{c}^{3}}{12} + {w}_{c} {{h}_{c} ( {\overline{y}}_{c} - \overline{Y} )}^{2} + \frac{{nw}_{p} {h}_{p}^{3}}{12} + {nw}_{p} {{h}_{p} ( {\overline{y}}_{p} - \overline{Y} )}^{2} .\end{matrix} \qquad ( 5 )$$

Now the terms, E_{c} and I′, can respectively replace E and I in Eq. 3. Next, the maximum deflection allowed by the strain limit of the flexure materials is explored. The deflection limit is limited by the conductor, so only calculations based upon the copper layer are presented. From simple beam theory, the maximum strain, θₘₐₓ, in a bending beam is related to the beam deflection as follows:

$${θ}_{max} = \frac{L {ɛ}_{max}}{( {h}_{c} + {h}_{p} - \overline{Y} )} . \qquad ( 6 )$$

In the above equation, εₘₐₓ is the yield strain of copper. For a 1 mm-wide, 12 μm-thick copper conductor laminated on 5.75 mm-wide, 12.7 μm-thick polyimide, the rotational stiffness is less than 0.25 mNm/rad. This flexure can achieve greater than ±10° of motion without plastic deformation. However, beam buckling due to the axial loads from the SMA actuators is also considered. The Euler buckling criterion for this flexure morphology is given as follows:

$${F}_{max} = \frac{{π}^{2} {E}_{c} {I}^{′}}{{( 0.5 L )}^{2}} . \qquad ( 7 )$$

Consequently, this flexure can withstand a force greater than 20N before buckling. In the case where this buckling strength is insufficient, an alternative flexure designs, such as an inversion flexure [see R. Wood, et al., “Microrobotics using composite materials: The micromechanical flying insect thorax,” 2003 Proc. IEEE Int. Conf. Robotics and Automation, vol. 2, pp. 1842-1849], can be used.

D. Generating Motion

By coordinating the rotation of each joint, undulatory motion can be created. A common method to create these motions is to drive each joint with an individual actuator and coordinate these rotations. However, one embodiment of the system is designed so that a single mode can be created with a single actuator, where each mode represents a certain shape of the tail. A timed sequence of multiple modes creates an undulatory motion. This method simplifies the control and design of the system because a single input can control multiple joints for a certain mode.

A single mode can be created by connecting two basic building blocks in series. Each building block is composed of multiple segments with an actuator fixed at the two end segments. Every joint has a mechanical stopper that defines the angle of each joint when the actuator is activated.

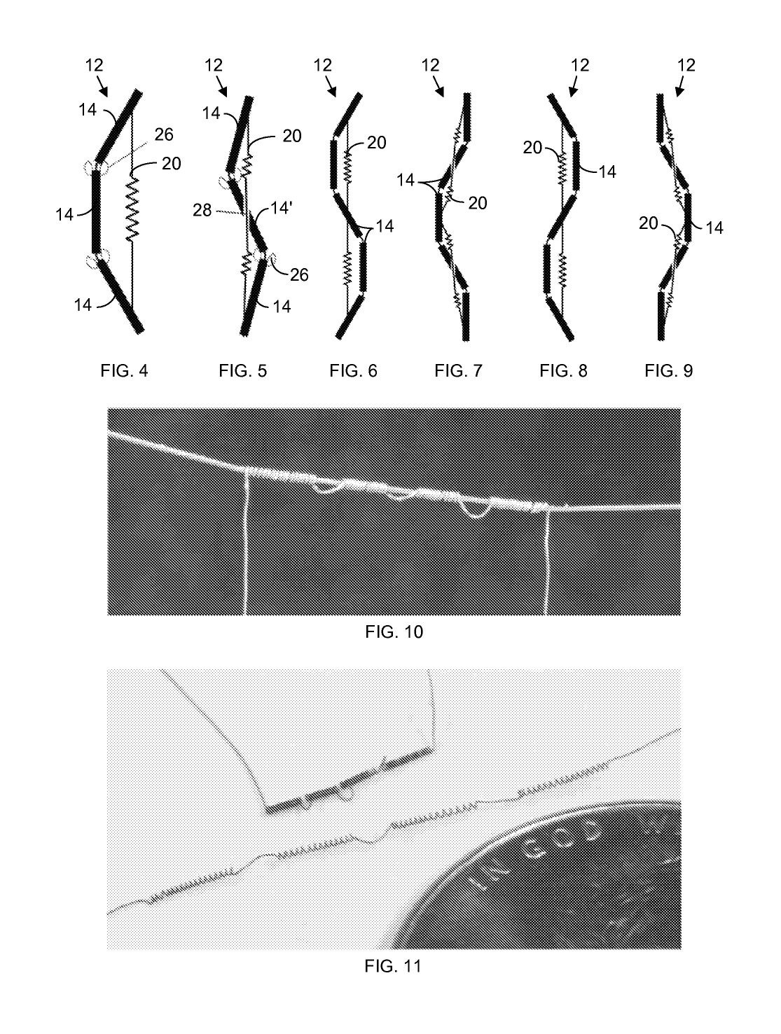

The two basic building blocks are shown in FIGS. 4 and 5. The C-type configuration (see FIG. 4) is created by mounting the actuator (spring) 20 on one side of the spine, with the actuator 20 fixed at the two end segments 14 and pivoting at the joints physically constrained by mechanical stoppers 26. The S-type configuration (see FIG. 5) is created by fixing an actuator 20 at one end, passing it through a hole in the middle segment 14′, and connecting the actuator 20 at the last segment 14 on the opposite side. The angle of the stopper 26 limits the rotation angle of the joints and defines the shape of the spine. The actuator 20 can generate enough force and displacement to rotate the joints until all stoppers 26 touch the adjoining segments 14.

Provided the actuator 20 passes through an attachment point of each segment 14, there is a single mode that can be created by the activation of the actuator 20. Variation of these two building blocks can be created by changing the number and the length of segments 14 and the stopping angles of each joint. Combining a mix of these two building blocks in series creates various mode shapes, each activated by a single actuator 20.

Subcarangiform swimming mode has been created by employing the two basic building blocks, discussed above; and the resulting motion is shown in FIGS. 6-9. There are two basic modes, where each mode has an antagonistic version. The modes shown in FIGS. 6 and 8 are a series combination of two C-types; and the modes in FIGS. 7 and 9 are a series combination of two S-types. The actuator 20 shown for each mode is a single actuator connected from one end to the other. The four modes are activated via a sequence from FIGS. 6 to 9, and repeating the sequence creates a continuous motion. Four actuators 20 are connected to segments 14 of the body frame, one for each mode. The actuators 20 should provide enough force and displacement when activated to create each mode, but should also be able to elongate when other actuators are activated to create other modes. Again, this capability is a benefit of SMA coil actuators as opposed to straight SMA actuator wires.

### II. Fabrication

A. SMA Coil Actuator Annealing

To achieve a spring-like geometry for a shape memory alloy, a high-temperature annealing process is used. The annealing process begins by stretching a support wire (wherein the wire has a diameter 2.5-3 times that of the SMA wire) between two adjustable clamps. Two loops are then tied in either end of the SMA, one of which is hooked onto an anchor attached to the near clamp, while the other loop is connected to a clip that is used as a handle for winding. Depending on the length of the spring, the SMA wire is wound around the support wire 10-20 times, keeping the coil tight and closed (i.e., with no space between loops). Multiple springs can be made on a single wire. FIG. 10 shows the SMA wire wound around a conducting mold wire for the annealing process. The number of springs and the spacing between the springs are customized based on the force and displacement requirements and on geometrical considerations.

For the robotic fish, four springs with a wire diameter of 760 μm, each with 17 windings, are wrapped with a spacing of about 0.8 mm between each spring. After wrapping, the clip is attached to the clamp and a weight is hung to keep tension as the support wire deforms. Current is run through the mold wire until the desired temperature is attained (e.g., read from a thermocouple). The lead wire is cut, and the springs are slid off and tested before use. FIG. 11 shows two sets of springs, one before stretching and the other one stretched and ready to be attached to the body frame.

By annealing SMA actuators at different temperatures, they will possess different phase transition temperatures. Therefore when the actuators are connected in series and a current is simultaneously passed through each of the actuators, the actuators will be activated at different times (i.e., sequentially). This sequential activation can be used to control the displacement of a single actuator in a stepper motor style.

The phase-transition temperatures of actuators can vary by, e.g., just 1 to 2° C. or by a total span as great as 60 to 70° C. In the latter case, an actuator toward one end of the device can have a phase-transition temperature at 30-40° C., while an actuator toward the opposite end of the device can have a phase transition temperature at 60-70° C., with the phase-transition temperature for each actuator between these two end actuators sequentially increasing from the end with the low-temperature transition to the end with the high-temperature transition.

B. Spine and Flexure Fabrication

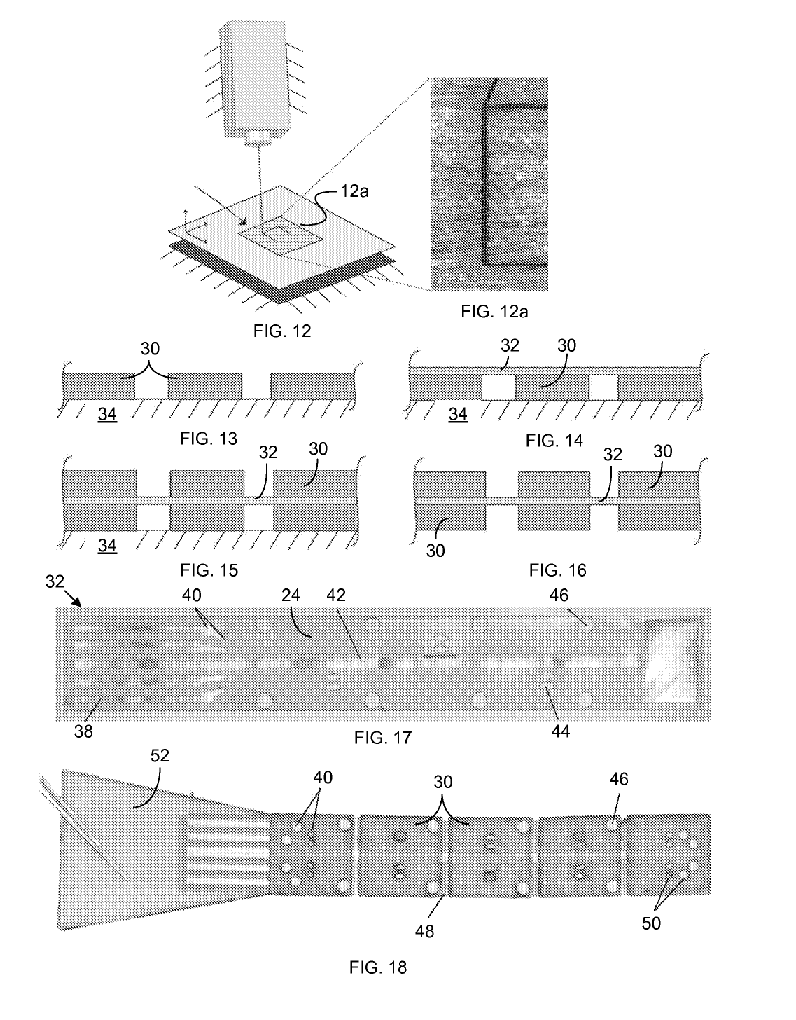

To overcome the limitations associated with traditional macro-scale manufacturing techniques for sub-millimeter-scale articulated devices, a meso-scale rapid prototyping method called Smart Composite Microstructures (SCM) has been developed. References herein to “meso-scale” are between macro-scale (e.g., machining) and micro-scale (e.g., microelectromechanical systems). This process entails the use of laminated, laser-micromachined materials stacked to achieve a desired compliance profile. FIGS. 12-16 provide an overview of the SCM process that is used to create the links and joints of the microrobotic fish spine. A strip of composite prepreg (i.e., a fiber structure preimpregnated with resin) is cut to a desired shape with a laser in FIG. 12. The laser-cut form of the prepreg is shown in FIG. 12a. The laser-cut prepreg segments 30 (with dimensions in the plane of the image of about 6 mm×6 mm) are then laid out across a substrate 34 with gaps between the segments 30, as shown in FIG. 13. A copper-laminated polyimide foil 32 (in the form of a flexible strip) is placed on top of the prepreg segments 30, as shown in FIG. 14; and additional laser-cut prepreg segments 30 are positioned on top of the copper-laminated polyimide foil 32, as shown in FIG. 15. The entire structure is cured to bond the layers, as shown in FIG. 16, producing the spine 12 or body frame, which can then be removed from the underlying substrate 34.

The copper-laminated polyimide foil 32 can (a) serve as the flexure material, (b) provide electrical connection, and (c) provide mechanical attachment points for the SMA actuators. As described above, a pair of perpendicularly aligned glass fiber layers are laminated on opposite sides of the copper-laminated polyimide foil 32. The copper foil is masked using kapton tape and a pattern is created from the copper foil using a laser cutter (e.g., a VERSALASER VLS3.5 laser). The tape is then peeled off from the sections that are to be etched with a ferric chloride solution. To align the features precisely, the polyimide layer is etched twice. First, the regions that are to be cut through are etched; and a pattern for the copper area is created with the laser cutter on the etched polyimide layer. Then, the foil is etched again to create the final shape. The resulting copper-laminated polyimide foil 32 is shown in FIG. 17, wherein the resulting copper pattern includes electrically conductive pathways 38 that are coupled to a circuit board and voltage source, SMA attachment pads 40, electrical wiring 42, SMA pass-through holes 44, and stopper positioning holes 46.

Each SMA spring is coupled at one end to a respective SMA attachment pad 40 toward the left side of the foil in FIG. 17 and at an opposite end to another electrical contact 50 on the foil to provide a conductive pathway for electrical current through each SMA spring. The SMA attachment pads 40 and the electrical contact(s) 50 at the opposite end are formed of an electrically conductive material (e.g., copper) and can all be connected with a power supply (e.g., a battery) to form a circuit for the flow of electric current. The SMA attachment pads 40 each are positioned at the end of a respective copper path 38, which is connected to a circuit board including the power supply and a micro controller programmed to direct electrical current from the power supply to each of the SMA springs in a designated sequence. The circuit board and associated components can all be incorporated into the tail 52 of the spine. Alternatively, these electronic components can be mounted in a separate power/control module. The body frame (with five rigid segments 30, four flexure joints 48 and the above-described electrical grid and apertures) is shown in FIG. 18.

C. Assembly

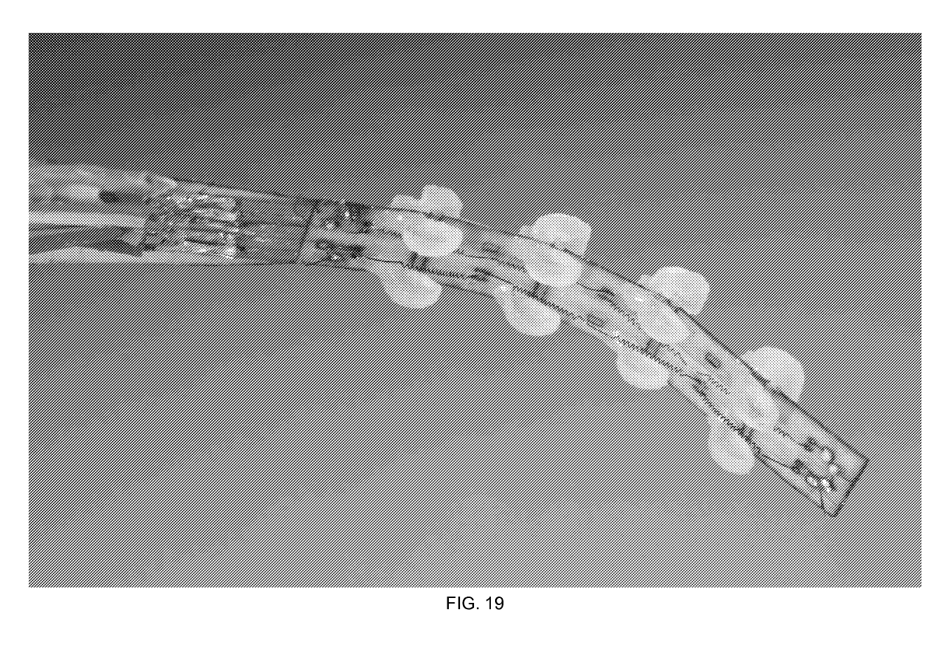

FIG. 19 shows an assembled robotic fish fin with four joints. The stoppers that define the joint angles are fabricated using a rapid prototyping machine (e.g., an INVISION SR 3D printer from 3D Systems, Inc., of Rock Hill, S.C.), which prints a plastic material (e.g., VISIJET SR200 plastic material from 3D Systems). The stoppers are built as a mating set, one with pegs and the other with holes. The stoppers are attached on both sides of each joint through the positioning holes with epoxy. The stopping angle is 25 degrees, and the height of the stoppers is 1.5 mm. The SMA actuators are soldered on the copper attachment pads with a sulfuric-acid-based liquid flux and a silver-bearing solder. The solder provides electrical contacts as well as mechanical connections. Either the actuators pass through a hole at the center of each segment or the actuators pass under a hook (e.g., made of glass fiber) to make sure that the actuators are positioned on top of the segments. The total length of the four-joint fish fin is 40 mm, with a height of 6 mm. The thickness of the body frame is approximately 250 microns.

### III. RESULTS

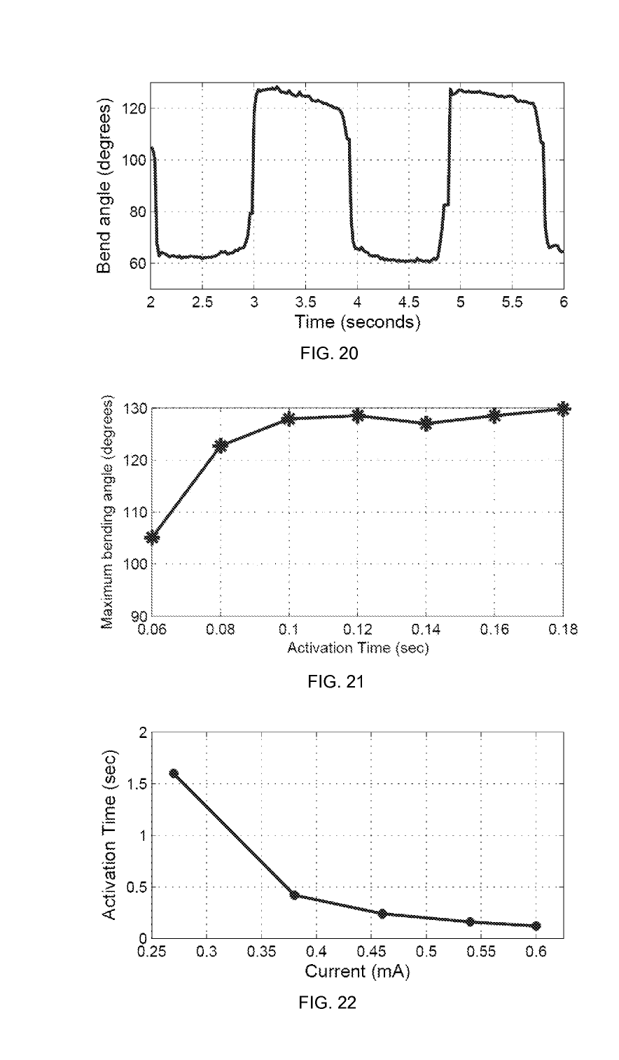

In order to characterize the robotic fish fin, a single joint with a size of 1 cm by 1 cm and having a SMA coil actuator with a diameter of 100 μm was built and tested. The SMA coil actuator was driven by two metal-oxide-semiconductor field-effect transistors (MOSFETs), which were controlled using xPC target real time control software from The Mathworks (Natick, Massachusetts). The motion was captured with a video camera to analyze the bending angle of the joints. An example of bending angle versus time is shown in FIG. 20, as the spring SMA actuator was activated with 0.6 A for 0.12 seconds, followed by a rest of 0.8 seconds, and as the antagonistic actuator was then activated. To choose the amount of activation time for a given current, a series of trials were run where the time interval was compared to the maximum bending angle (e.g., see FIG. 21 for 0.6 A). For each current level, the time at which the saturation point is reached was chosen, thus minimizing power input and preventing overheating.

Energy efficiency increases with increasing current since the activation time decreases, which also decreases the amount of heat loss during activation. As displayed in FIG. 22, the activation time decreases exponentially with increasing current; but the current amplitude is limited by the power supply on board.

To activate a 100 μm-wire-diameter SMA spring actuator, current of 0.6 A is supplied at 1.09 V. To obtain a maximum bending angle, the current is applied for 0.12 seconds. Since a single cycle requires the activation of two antagonistic actuators, 0.15W are consumed per cycle. To put this in perspective, using a lithium polymer battery rated at 20 mAh with 3.7V nominal output and weighing 1 gram (e.g., a KOKAM SLB455018 battery from Kokam America of Lee's Summit, Mo.), about 1696 cycles can be performed, assuming that the losses from other electronic components are minimal. For a 2 Hz motion, 1696 cycles corresponds to a continuous operation time of around 14 minutes.

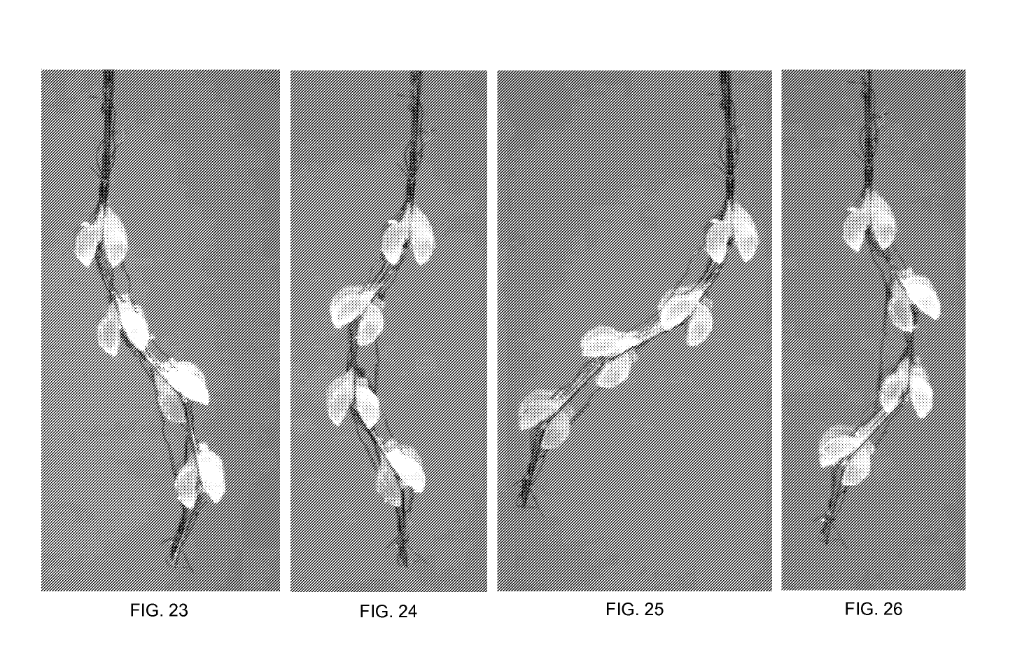

The final robotic fish fin was tested to activate each mode shown in FIGS. 6-9. Each mode was created by activating the four actuators in sequence. The actuators and holes were configured to allow the actuators to move freely in the pass-through holes when changing from one mode to the other; and sufficient moment was provided to pull the segments that are bent in the other direction in the previous mode. The resulting shapes from an initial experiment of activating each mode are shown in FIGS. 23-26.

### IV. Applications and Customization

A body-caudal fin propulsion system using SMA spring actuators mounted on a multi-segmented, flexure-based frame is described herein. The system can be built with integrated electronics and covered with a protective skin.

The design and fabrication techniques, presented above, are simple, robust, and scalable. By customizing the SMA spring actuators, an actuated flexure joint can be created with a range of displacements and forces, instead of the set amount of strain and force that straight-wire SMA actuators provide. Flexures, electrical wiring, and actuator attachment points are all embedded into a copper-laminated polyimide foil patterned with copper traces, solder pads and other features for assembly. Because of the simplicity in design and fabrication of the system and because the actuator characteristics can be customized, the segmented system with SMA actuators can alternatively be used as a backbone of various other small-scale robots. Undulatory motion is created by using a sequence of mode shapes. This scheme of using a single actuator to create a single mode that coordinates multiple joint angles further simplifies the design and control of the device.

Varying each segment length to fit the natural motion of a fish as well as increasing the total number of segments can produce a more-realistic tail motion. Control of this motion can also be optimized using pulse-width modulation (PWM), allowing for concurrent actuation and thus smoother motion.

One of the more exciting potential uses of the spine is in an autonomous or controlled in-vivo-diagnosis robot, equipped with video and other sensors. The actuated spine allows controlled motion in the digestive tract or on a smaller scale in the circulatory system. Other uses of such a small aquatic robot include surveillance and search and rescue. Defense applications in monitoring ports can utilize inexpensive autonomous robots of this design; the robots can be allowed to search a harbor and only report back (e.g., via an incorporated wireless transmitter) if a suspicious item is found. Surveillance can also include environmental monitoring, where inexpensive robots of this design can be released into a lake or a river to search for harmful chemicals, wherein chemical sensors detect the presence of such chemicals and send signals to an on-board computer processor programmed to generate and communicate a report as to what is found. Search and rescue may be a more-limited application, though many cave divers are lost each year in underwater caves, and searches for lost divers can quickly be made by a fleet of these disposable robotic fish.

The SMA actuator can provide substantial benefits for any robotic system that currently utilizes SMA artificial muscles. In previous robots, an operator could either turn an actuator on or turn the actuator off; the operator could also attempt to achieve a partial “on” by hitting the exact transition temperature and obtaining a partial contraction. This latter method is not robust and cannot create accurate contraction lengths. The apparatus and method described herein allows contraction as in biological systems, similar to the way that real muscles are able to contract to specified lengths. This apparatus and method are especially useful in microrobotics, where electric motors are no longer feasible.

In describing embodiments of the invention, specific terminology is used for the sake of clarity. For the purpose of description, specific terms are intended to at least include technical and functional equivalents that operate in a similar manner to accomplish a similar result. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Further, where parameters for various properties are specified herein for embodiments of the invention, those parameters can be adjusted up or down by 1/100^{th}, 1/50^{th}, 1/20^{th}, 1/10^{th}, 1/5^{th}, 1/3^{rd}, 1/2, 3/4^{th}, etc. (or up by a factor of 2, 5, 10, etc.), or by rounded-off approximations thereof, unless otherwise specified. Moreover, while this invention has been shown and described with references to particular embodiments thereof, those skilled in the art will understand that various substitutions and alterations in form and details may be made therein without departing from the scope of the invention. Further still, other aspects, functions and advantages are also within the scope of the invention; and all embodiments of the invention need not necessarily achieve all of the advantages or possess all of the characteristics described above. Additionally, steps, elements and features discussed herein in connection with one embodiment can likewise be used in conjunction with other embodiments. The contents of references, including reference texts, journal articles, patents, patent applications, etc., cited throughout the text are hereby incorporated by reference in their entirety. Appropriate components and methods of those references may be selected for the invention and embodiments thereof. Still further, the components and methods identified in the Background section are integral to this disclosure and can be used in conjunction with or substituted for components and methods described elsewhere in the disclosure within the scope of the invention. In method claims, where stages are recited in a particular order—with or without sequenced prefacing characters added for ease of reference—the stages are not to be interpreted as being temporally limited to the order in which they are recited unless otherwise specified or implied by the terms and phrasing.

What is claimed is:

1. A multi-segmented spine with integrated actuation comprising:
a plurality of rigid segments separated from each other with gaps;
a flexible coupling joining the rigid segments, the flexible coupling being more flexible than the rigid segments to promote bending of the spine at the gaps between the rigid segments; and
a plurality of integrated actuators, each coupled with at least two of the rigid segments, the integrated actuators each having a shape that changes upon activation by an external stimulus to flex the spine at the flexible coupling between the rigid segments to which the activated actuator is coupled.

2. The multi-segmented spine of claim 1, wherein the integrated actuators are configured to produce displacement in response to a stimulus selected from the following: electricity, temperature change, light, change in pH, chemical reaction, and combinations thereof.

3. The multi-segmented spine of claim 1, further comprising:
electrically conductive pathways extending along the spine and coupled with the integrated actuators; and
a voltage source coupled with the electrically conductive pathways.

4. The multi-segmented spine of claim 1, wherein the integrated actuators comprise a shape memory alloy.

5. The multi-segmented spine of claim 1, wherein the spine has a length no greater than about 4 cm.

6. The multi-segmented spine of claim 1, wherein at least one of the integrated actuators passes through at least one of the rigid segments between the rigid segments to which that integrated actuator is coupled to produce an S-type configuration of segments when contracted, and wherein at least one of the integrated actuators remains on the same side of the spine to produce a C-type configuration of segments when contracted.

7. A multi-segmented spine with integrated actuation comprising:
a flexible strip comprising electrically conductive pathways;
a plurality of springs comprising a shape memory alloy electrically coupled with the conductive pathways to bend the flexible strip when electric current is provided via at least one of the conductive pathways through at least one of the springs; and
a voltage source coupled with the conductive pathways to provide electrical current through the conductive pathways and springs.

8. The multi-segmented spine of claim 7, wherein the flexible strip comprises a plurality of rigid segments separated by flexible segments, and wherein the rigid segments are more rigid than the flexible segments.

9. The multi-segmented spine of claim 8, wherein opposite ends of each spring are respectively coupled with discrete rigid segments.

10. The multi-segmented spine of claim 9, wherein at least one of the springs passes through at least one of the rigid segments between the rigid segments to which that spring is coupled to produce an S-type configuration of segments when contracted, and wherein at least one of the springs remains on the same side of the flexible strip to produce a C-type configuration of segments when contracted.

11. The multi-segmented spine with integrated actuation of claim 9, wherein mechanical stoppers are mounted to the rigid segments to limit the degree to which the flexible strip can flex between adjacent rigid segments.

12. The multi-segmented spine of claim 7, wherein the spine has a length, measured along its greatest dimension, of no more than about 4 cm.

13. The multi-segmented spine of claim 7, wherein the springs comprise coils.

14. The multi-segmented spine of claim 13, wherein the coils have transition temperatures that span a range of at least 4° C.

15. A method for propelling a multi-segmented spine comprising:
providing a multi-segmented spine with integrated actuation, the multi-segmented spine including a plurality of rigid segments joined with a flexible coupling and a plurality of integrated actuators; and
applying an external stimulus to the integrated actuators to pivot a plurality of the rigid segments in sequence to move the multi-segmented spine.

16. The method of claim 15, wherein the multi-segmented spine is placed in or on a fluid.

17. The method of claim 16, wherein the fluid is a liquid.

18. The method of claim 16, wherein the integrated actuators comprise springs comprising a shape memory alloy and the stimulus comprises at least one of electrical voltage and heat.

19. The method of claim 18, wherein the springs sequentially contract or expand to generate an undulatory motion along the spine that propels the spine through the fluid via subcarangiform locomotion.

20. The method of claim 15, wherein segments of the flexible strip flex at an operational speed of 2-4 Hz.
